(19) United States
(12) Patent Application Publication
(10) Pub. No.: US 2020/0292961 A1
(43) Pub. Date: Sep. 17, 2020

(54) IMAGE FORMING APPARATUS

(71) Applicant: TOSHIBA TEC KABUSHIKI KAISHA, Tokyo (JP)

(72) Inventor: Masato OGASAWARA, Katsushika Tokyo (JP)

(21) Appl. No.: 16/353,594

(22) Filed: Mar. 14, 2019

(51) Int. Cl. G03G 15/08

(52) U.S. Cl. CPC G03G 15/0865

(57) ABSTRACT

An image forming apparatus includes first and second image forming units, each including a developing device, a non-developing device, and an image carrier between the developing device and the non-developing device. The non-developing device of the first image forming unit is adjacent to the developing device of the second image forming unit. The apparatus includes a belt above the developing device, the non-developing device, and the image carrier of the image forming units, that moves as the image carrier rotates. A first gap between the non-developing device of the first image forming unit and the belt is larger than a second gap between the developing device of the second image forming unit and the belt. A third gap between the non-developing device of the first image forming unit and the developing device of the second image forming unit is smaller than the second gap.

### FIELD

Embodiments described herein relate generally to an image forming apparatus.

### BACKGROUND

There has been an image forming apparatus such as a multi function peripheral (hereinafter referred to as “MFP”) or a printer. The image forming apparatus includes a developing device that stores a developer. The developing device includes a developing roller. If the air enters the developing device according to rotation of the developing roller, the pressure in the developing device increases. If the pressure in the developing device increases, the air including toner in the developing device sometimes blows out to the outside of the developing device. If the air including the toner blows out to the outside of the developing device, the toner scatters to the outside of the developing device. As a result, some components in the image forming unit such as a charging device are likely to be soiled. In an image forming apparatus including a plurality of image forming units, i.e., including a plurality of developing devices therein, the other components in each image forming unit may be soiled by toner scattering from the adjacent developing devices.

DESCRIPTION OF THE DRAWINGS

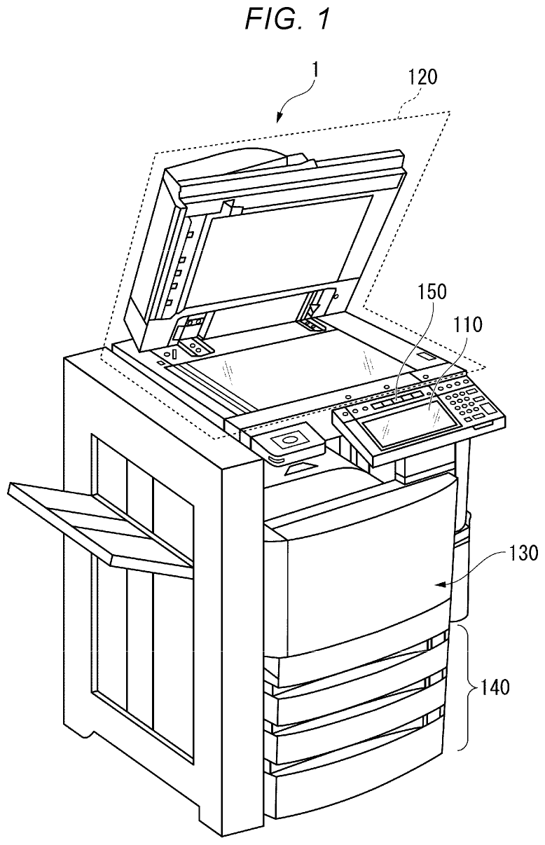

FIG. 1 is an exterior view of an image forming apparatus in an embodiment;

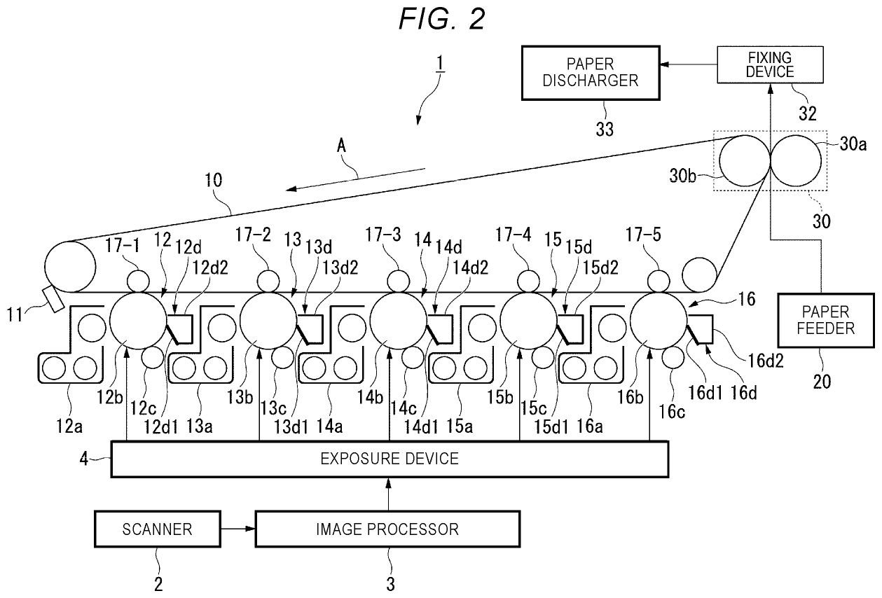

FIG. 2 is a schematic diagram of the image forming apparatus;

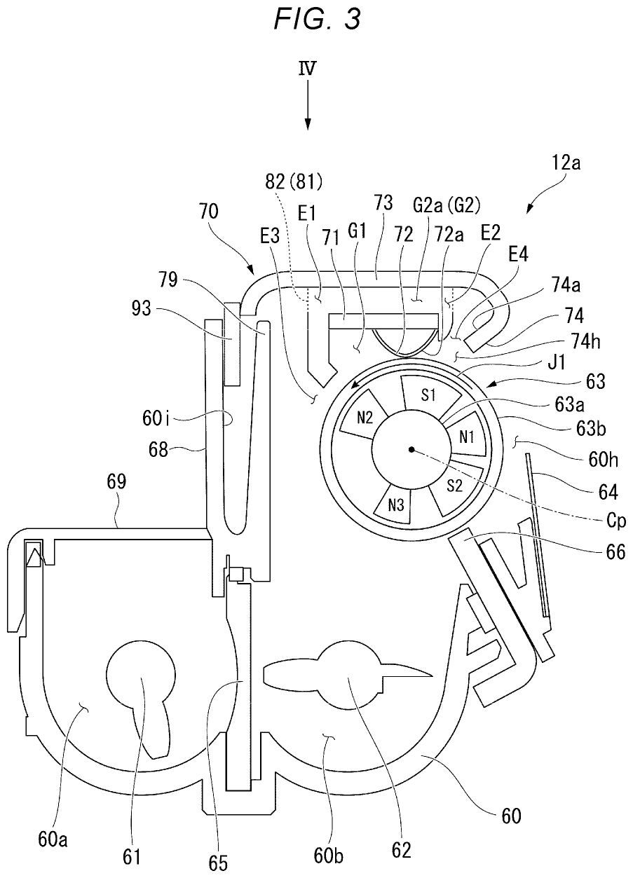

FIG. 3 is a sectional view of a developing device in the embodiment;

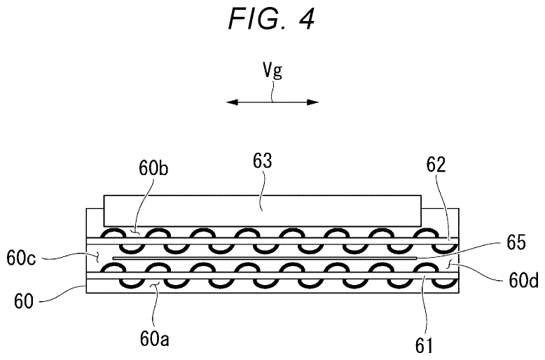

FIG. 4 is a IV arrow view of FIG. 3;

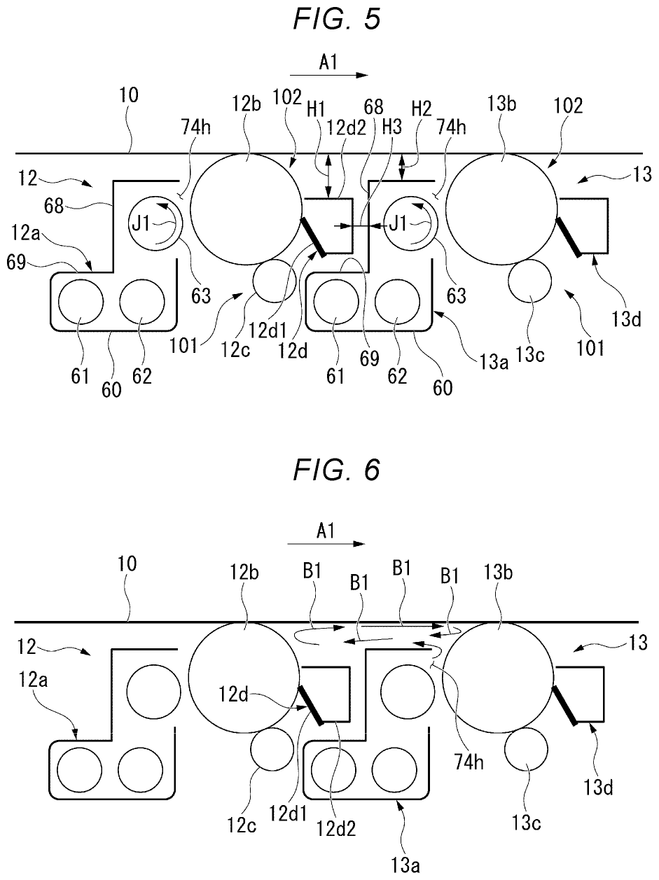

FIG. 5 is a side view of a first image forming unit and a second image forming unit in the embodiment;

FIG. 6 is a side view of the first and the second image forming unit for explaining a flow of air around the developing device;

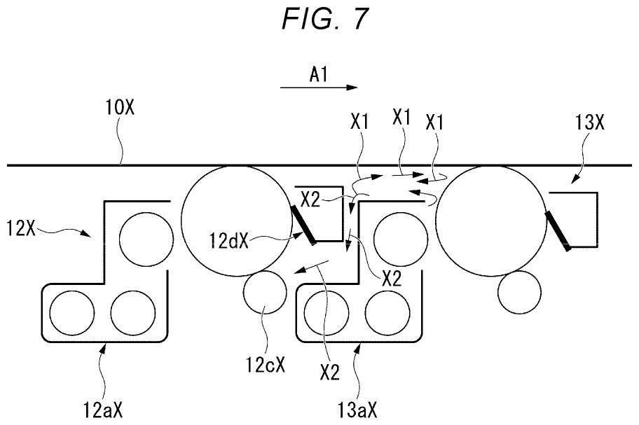

FIG. 7 is a side view of image forming units for explaining a flow of air around a developing device in a comparative example;

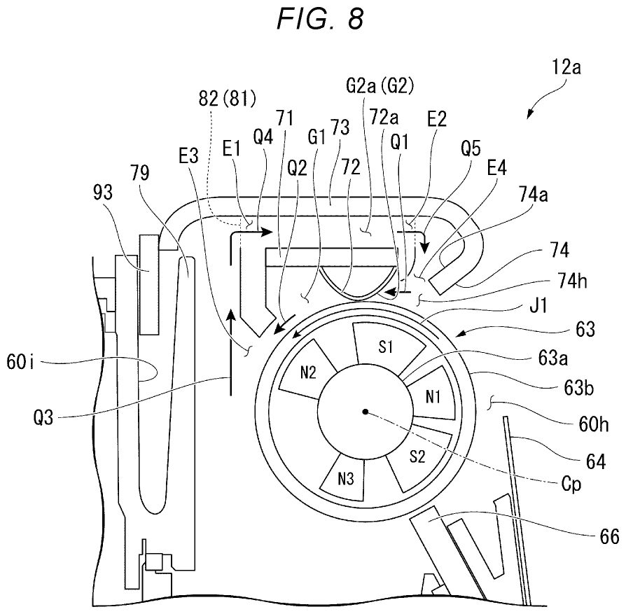

FIG. 8 is a sectional view of the developing device for explaining a flow of air therein in the embodiment;

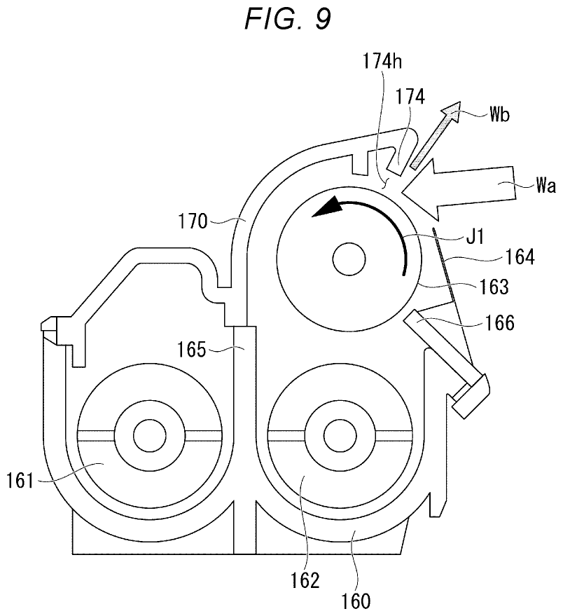

FIG. 9 is a sectional view of the developing device for explaining toner scattering therein;

FIG. 10 is a sectional view of a circulation-type developing device for explaining a flow of air therein;

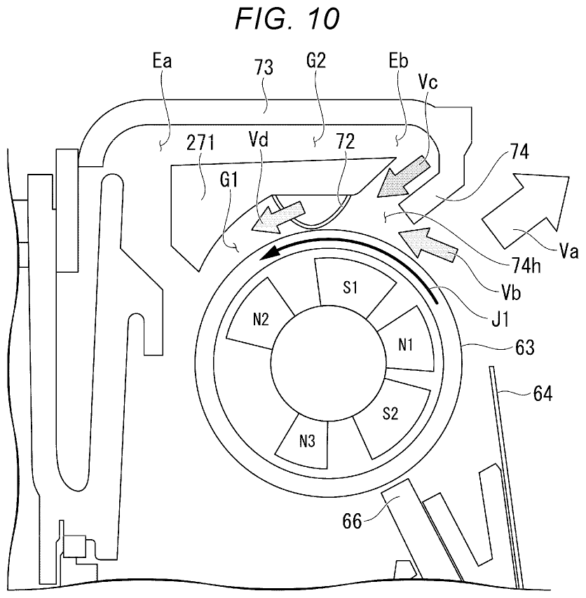

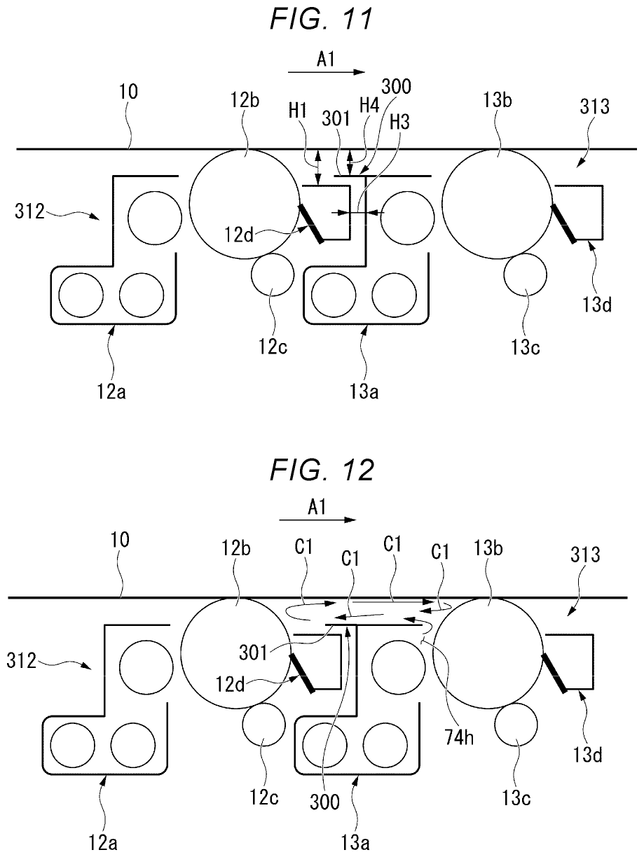

FIG. 11 is a side view of a first image forming unit and a second image forming unit in a first modification of the embodiment;

FIG. 12 is a side view of a developing device for explaining a flow of air around therein in the first modification;

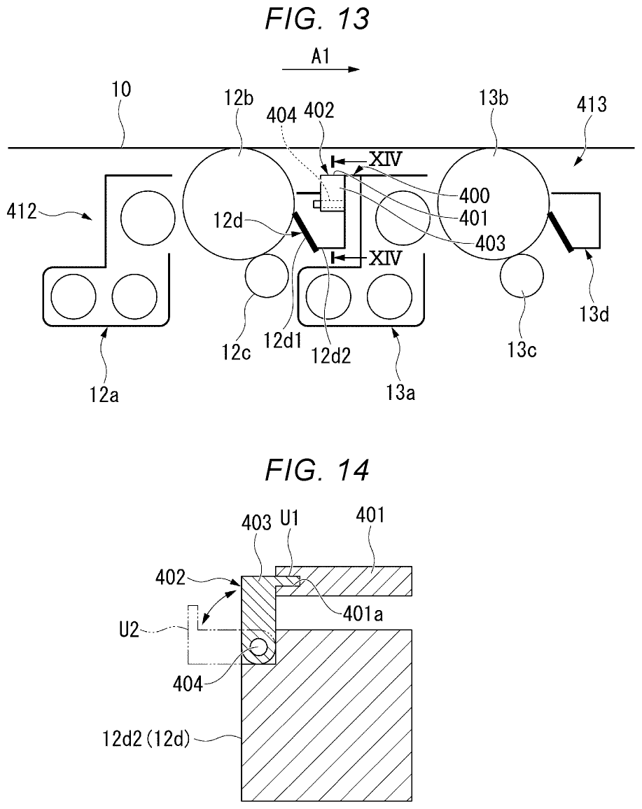

FIG. 13 is a side view of a first image forming unit and a second image forming unit in a second modification of the embodiment;

FIG. 14 is a diagram including a XIV-XIV section of FIG. 13;

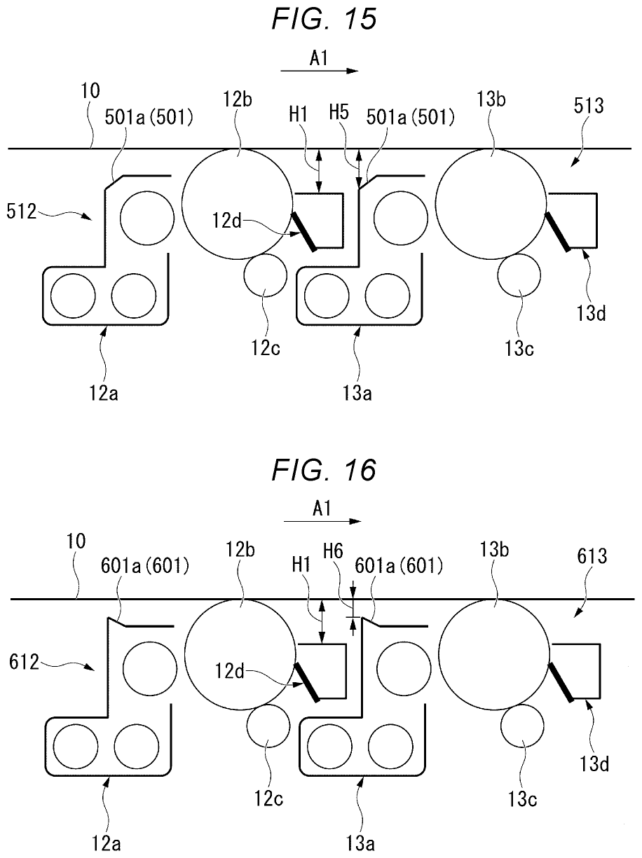

FIG. 15 is a side view of a first image forming unit and a second image forming unit in a third modification of the embodiment; and

FIG. 16 is a side view of a first image forming unit and a second image forming unit in a fourth modification of the embodiment.

### DETAILED DESCRIPTION

In general, according to one embodiment, an image forming apparatus includes first and second image forming units, each including a developing device, a non-developing device, and an image carrier between the developing device and the non-developing device. The non-developing device of the first image forming unit is adjacent to the developing device of the second image forming unit. The apparatus includes a belt above the developing device, the non-developing device, and the image carrier of the image forming units, that moves as the image carrier rotates. A first gap between an upper surface of the non-developing device of the first image forming unit and the belt is larger than a second gap between an upper surface of the developing device of the second image forming unit and the belt. A third gap between aside surface of the non-developing device of the first image forming unit and a side surface of the developing device of the second image forming unit is smaller than the second gap.

The image forming apparatus in the embodiment is explained below with reference to the drawings. In the figures, the same components are denoted by the same reference numerals and signs.

FIG. 1 is an exterior view of an image forming apparatus 1 in the embodiment. For example, the image forming apparatus 1 is a multi function peripheral (MFP). The image forming apparatus 1 reads an image formed on a sheet-like recording medium (hereinafter referred to as “sheet”) such as paper and generates digital data (an image file). The image forming apparatus 1 forms an image on the sheet using toner on the basis of the digital data.

The image forming apparatus 1 includes a display 110, an image scanner 120, an image forming unit 130, and a sheet tray 140.

The display 110 operates as an output interface and displays characters and images. The display 110 operates as an input interface as well and receives an instruction from a user. For example, the display 110 is a touch panel-type liquid crystal display.

For example, the image scanner 120 is a color scanner. As the color scanner, there are a contact image sensor (CIS) and a charge coupled device (CCD). The image scanner 120 reads an image formed on a sheet using a sensor and generates digital data.

The image forming unit 130 forms an image on a sheet using toner. The image forming unit 130 forms an image on the basis of image data read by the image scanner 120 or image data received from an external apparatus. For example, the image formed on the sheet is an output image called hard copy or printout.

The sheet tray 140 supplies, to the image forming unit 130, a sheet used for image output.

FIG. 2 is a schematic diagram of the image forming apparatus 1 in the embodiment. The image forming apparatus 1 is an electrophotographic image forming apparatus. The image forming apparatus 1 is a quintuple tandem type image forming apparatus.

Examples of the toner include a decoloring toner, a non-decoloring toner (e.g., a regular toner), and a decorative toner. The decoloring toner is decolored by an external stimulus. “Decoloring” means that an image formed in a color (including not only a chromatic color but also an achromatic color such as white or black) different from a color of a foundation of paper is made invisible. For example, the external stimulus is temperature, light having a specific wavelength, or pressure. In the embodiment, the decoloring toner is decolored if the temperature of the decoloring toner reaches a specific decoloring temperature or more. The decoloring toner develops a color if the temperature of the decoloring toner reaches a specific restoration temperature or less after being decolored.

Any toner may be used as the decoloring toner if the toner has the characteristics explained above. For example, a coloring agent of the decoloring toner may be a leuco dye. A color developing agent, a decoloring agent, a discoloring temperature adjusting agent, and the like maybe combined with the decoloring toner as appropriate.

A fixing temperature of the decoloring toner is low compared with a fixing temperature of the non-decoloring toner. The fixing temperature of the decoloring toner means temperature of a heat roller during a decoloring toner mode explained below. A fixing temperature of the non-decoloring toner means temperature of the heat roller during a monochrome toner mode or during a color toner mode explained below.

The fixing temperature of the decoloring toner is low compared with temperature of decoloring processing of the decoloring toner. The temperature of the decoloring processing of the decoloring toner means temperature of the heat roller of a fixing device 32 during a decoloring mode.

The image forming apparatus 1 includes a scanner 2, an image processor 3, an exposure device 4, an intermediate transfer body 10 (e.g., a belt), a cleaning blade 11, image forming units 12 to 16, primary transfer rollers 17-1 to 17-5, a paper feeder 20, a secondary transfer unit 30, a fixing device 32, a paper discharger 33, and a controller (not illustrated in FIG. 2). In the following explanation, the primary transfer rollers 17-1 to 17-5 are simply described as primary transfer rollers 17 if the primary transfer rollers 17-1 to 17-5 are not distinguished.

In the following explanation, since a sheet is conveyed from the paper feeder 20 to the paper discharger 33, the paper feeder 20 side is set as an upstream side with respect to a sheet conveying direction Vs and the paper discharger 33 side is set as a downstream side with respect to the sheet conveying direction Vs.

As transfer in the image forming apparatus 1, there are a first transfer process and a second transfer process. In the first transfer process, the primary transfer rollers 17 transfer images by toners on photoconductive drums of the image forming units onto the intermediate transfer body 10. In the second transfer process, the secondary transfer unit 30 transfers images by toners of colors stacked on the intermediate transfer body 10 onto a sheet.

The scanner 2 reads an image formed on a sheet set as a scanning target. For example, the scanner 2 reads the image on the sheet and generates image data of the three primary colors of red (R), green (G), and blue (B). The scanner 2 outputs the generated image data to the image processor 3.

The image processor 3 converts the image data into color signals of the colors. For example, the image processor 3 converts the image data into image data (e.g., color signals) of four colors of yellow (Y), magenta (M), cyan (C), and black (K). The image processor 3 controls the exposure device 4 on the basis of the color signals.

The exposure device 4 irradiates or exposes light on the photoconductive drums of the image forming units. The exposure device 4 includes an exposure light source such as a laser or an LED.

The intermediate transfer body 10 is an endless belt. The intermediate transfer body 10 is rotating in an arrow A direction in FIG. 2. Images of toners are formed on the surface of the intermediate transfer body 10. The intermediate transfer body 10 is in contact with the respective photoconductive drums of a plurality of image forming units 12 to 16. The intermediate transfer body 10 moves according to rotation of the photoconductive drums.

The cleaning blade 11 removes toner adhering to the intermediate transfer body 10. For example, the cleaning blade 11 is a tabular member. For example, the cleaning blade 11 is made of resin such as urethane resin.

The image forming units 12 to 16 form images using toners of colors (e.g., five colors in FIG. 2). The image forming units 12 to 16 are arranged along the intermediate transfer body 10.

The primary transfer rollers 17 (i.e., 17-1 to 17-5) are used when the images by the toners formed by the image forming units 12 to 16 are transferred onto the intermediate transfer body 10.

The paper feeder 20 feeds a sheet.

The secondary transfer unit 30 includes a secondary transfer roller 30a and a secondary transfer counter roller 30b. The secondary transfer unit 30 transfers the images formed by the toners on the intermediate transfer body 10 onto the sheet.

In the secondary transfer unit 30, the intermediate transfer body 10 and the secondary transfer roller 30a are in contact. In view of improving a paper jam, the intermediate transfer body 10 and the secondary transfer roller 30a may be separable.

The fixing device 32 fixes the images by the toners transferred onto the sheet on the sheet with heating and pressurization. The sheet on which an image is formed by the fixing device 32 is discharged to the outside of the apparatus from the paper discharger 33.

The image forming units 12 to 16 are explained. The image forming units 12 to 15 respectively store toners of colors corresponding to four colors for color printing. The four colors for color printing are colors of yellow (Y), magenta (M), cyan (C), and black (K). The toners of the four colors for color printing are non-decoloring toners. The image forming unit 16 stores a decoloring toner. The image forming units 12 to 15 and the image forming unit 16 have the same configuration, although the toners stored therein are different. Therefore, the image forming unit 12 representing the image forming units 12 to 16 is explained. Explanation about the other image forming units 13 to 16 is omitted.

The image forming unit 12 includes a developing device 12a, a photoconductive drum 12b, a charging device 12c, and a cleaning unit 12d.

The developing device 12a stores a developer. The developer includes toner. The developing device 12a deposits the toner on the photoconductive drum 12b. For example, the toner is used as a one-component developer or combined with a carrier and used as a two-component developer. For example, as the carrier, iron powder or polymer ferrite particles having a particle diameter of several ten micrometers are used. In the embodiment, a two-component developer including a nonmagnetic toner is used.

The photoconductive drum 12b is one specific example of an image carrier. The photoconductive drum 12b includes a photoconductive body (or a photoconductive region) on the outer circumference of the photoconductive drum 12b. For example, the photoconductive body is an organic photoconductor (OPC).

The charging device 12c uniformly charges the surface of the photoconductive drum 12b.

The cleaning unit 12d includes a cleaning blade 12d1 and a cleaner case 12d2. The cleaning blade 12d1 removes toner adhering to the photoconductive drum 12b. The cleaner case 12d2 covers the cleaning blade 12d1 from the opposite side of the photoconductive drum 12b.

An overview of the operation of the image forming unit 12 is explained.

The photoconductive drum 12b is charged to predetermined potential by the charging device 12c. Subsequently, light is irradiated on the photoconductive drum 12b from the exposure device 4. Consequently, the potential of a region where the light is irradiated in the photoconductive drum 12b changes. According to the change, an electrostatic latent image is formed on the surface of the photoconductive drum 12b. The electrostatic latent image on the surface of the photoconductive drum 12b is developed by the developer of the developing device 12a. That is, an image developed by the toner (hereinafter, “developed image”) is formed on the surface of the photoconductive drum 12b.

The developed image formed on the surface of the photoconductive drum 12b is transferred onto the intermediate transfer body 10 by the primary transfer roller 17-1 opposed to the photoconductive drum 12b in a first transfer process.

The first transfer process in the image forming apparatus 1 is explained. First, the primary transfer roller 17-1 opposed to the photoconductive drum 12b transfers the developed image on the photoconductive drum 12b onto the intermediate transfer body 10. Subsequently, the primary transfer roller 17-2 opposed to a photoconductive drum 13b transfers a developed image on the photoconductive drum 13b onto the intermediate transfer body 10. Such processing is performed in photoconductive drums 14b, 15b, and 16b as well. At this time, developed images on the photoconductive drums 12b to 16b are transferred onto the intermediate transfer body 10 so as to overlap one another. For that reason, the developed images by the toners of the colors are superimposed and transferred onto the intermediate transfer body 10 that is passed through the image forming unit 16.

However, if image formation using only the non-decoloring toner is performed, the image forming units 12 to 15 operate. A developed image formed using only the non-decoloring toner is formed on the intermediate transfer body 10 by such operation. If image formation using only the decoloring toner is performed, the image forming unit 16 operates. A developed image formed using only the decoloring toner is formed on the intermediate transfer body 10 by such operation.

A second transfer process is explained. A voltage (a bias) is applied to the secondary transfer counter roller 30b. For that reason, an electric field is generated between the secondary transfer counter roller 30b and the secondary transfer roller 30a. The secondary transfer unit 30 transfers, with the electric field, the developed image formed on the intermediate transfer body 10 onto a sheet.

Types of image formation processing executed by the image forming apparatus 1 (see FIG. 1) in the embodiment are explained. The image forming apparatus 1 executes printing in three modes described below.

Monochrome toner mode: An image is formed by a non-decoloring toner of a black single color.

Color toner mode: An image is formed by a non-decoloring monochrome toner and non-decoloring color toners.

Decoloring toner mode: An image is formed by only a decoloring toner.

The user can select one of the modes, by operating the display 110 of the image forming apparatus 1.

In the monochrome toner mode, an image forming unit using a non-decoloring toner of black (K) operates, whereby an image is formed. The monochrome toner mode is a mode selected if the user desires to print a general monochrome image. For example, the monochrome toner mode is used, for example, if the user desires to store important documents and the like without recycling paper.

In the color toner mode, four image forming units using respective non-decoloring toners of yellow (Y), magenta (M), cyan (C), and black (K) operate, whereby an image is formed. The color toner mode is a mode selected if the user desires to print a color image.

In the decoloring toner mode, only an image forming unit using a decoloring toner operates, whereby an image is formed. The decoloring toner mode is a mode selected if paper on which an image is formed is recycled.

The fixing device 32 is controlled to a fixing mode and a decoloring mode. In the fixing mode, a toner image is fixed on a sheet. In the decoloring mode, the toner image is decolored on the sheet. In the decoloring mode, the temperature of a heat roller is set higher than the temperature during the fixing mode. That is, the controller (not illustrated in FIG. 2) causes the fixing device 32 to operate at least at two or more target temperatures. Specifically, two target temperatures of the fixing device 32 are stored in a memory (not illustrated in FIG. 2). The controller reads a target temperature from the memory according to a selected mode and causes the fixing device 32 to operate. The two target temperatures are a first temperature and a second temperature. The first temperature is temperature during the decoloring mode. The second temperature is temperature during the fixing mode. That is, the second temperature is temperature lower than the first temperature. As illustrated in FIG. 1, the display 110 includes a button 150 for switching the fixing device 32 from the decoloring mode to the fixing mode.

The developing device 12a is explained. FIG. 3 is a sectional view of the developing device 12a in the embodiment. In FIG. 3, cross section hatching is omitted.

As illustrated in FIG. 3, the developing device 12a includes a housing 60, a first mixer 61, a second mixer 62, a developing roller 63, a shield section 64, a gap forming member 71, a blocking member 72, and a guide section 74.

The housing 60 stores a developer. The developer includes a carrier, which is a magnetic body, and toner functioning as a coloring material. The first mixer 61 and the second mixer 62 are disposed on the inside of the housing 60. An opening section 60h for exposing a part of the developing roller 63 is formed on a side opposed to the photoconductive drum 12b (see FIG. 2) in the housing 60. In this embodiment, the housing 60 includes the developing device 12a. However, the housing 60 may include a frame of the image forming apparatus 1 other than the developing device 12a. The housing 60 and the gap forming member 71 may be integrally molded or may be separate members.

FIG. 4 is a IV arrow view of FIG. 3. In FIG. 4, illustration of the gap forming member 71, the blocking member 72, and the like is omitted.

As illustrated in FIG. 4, the first mixer 61 and the second mixer 62 are disposed in parallel to each other. The first mixer 61 functions as a developer agitating section that agitates the developer. The second mixer 62 functions as a developer supplying section that supplies the developer.

A first chamber 60a, in which the first mixer 61 is disposed, is formed in the housing 60. A second chamber 60b, in which the second mixer 62 is disposed, is formed in the housing 60. A partition wall 65 that partitions the first chamber 60a and the second chamber 60b is provided in the housing 60. The first chamber 60a and the second chamber 60b are adjacent to each other across the partition wall 65. Side openings 60c and 60d for circulating the developer between the first chamber 60a and the second chamber 60b are formed on both sides in a rotation axis direction Vg of the developing roller 63 in the housing 60. In the following explanation, the rotation axis direction Vg of the developing roller 63 is referred to as “roller axis direction Vg” as well.

As illustrated in FIG. 3, the developing roller 63 is rotatable in the housing 60. The developing roller 63 carries the developer with a magnetic force of a magnetic body. The developing roller 63 is opposed to the photoconductive drum 12b (see FIG. 2) via the opening section 60h. The developing roller 63 is disposed on the second chamber 60b side.

The developing roller 63 includes a shaft section 63a, a plurality of magnetic pole sections N1, S1, N2, N3, and S2, and a sleeve 63b.

The shaft section 63a extends in the roller axis direction Vg (see FIG. 4). Both end portions of the shaft section 63a are fixed to the housing 60.

The plurality of magnetic pole sections N1, S1, N2, N3, and S2 are fixed to the shaft section 63a. The plurality of magnetic pole sections N1, S1, N2, N3, and S2 are fixed in fixed positions at intervals in the circumferential direction of the shaft section 63a. For example, the plurality of magnetic pole sections N1, S1, N2, N3, and S2 are magnets.

The plurality of magnetic pole sections N1, S1, N2, N3, and S2 are a development pole N1, a first conveyance pole S1, a peeling pole N2, a grasping pole N3, and a second conveyance pole S2. The development pole N1 is opposed to the photoconductive drum 12b across the sleeve 63b to bring the developer carried on the developing roller 63 close to the photoconductive drum 12b (see FIG. 2). The plurality of magnetic pole sections N1, S1, N2, N3, and S2 are disposed in the order of the first conveyance pole S1, the peeling pole N2, the grasping pole N3, and the second conveyance pole S2 downstream in a rotating direction J1 of the developing roller 63 on the basis of the development pole N1. In the following explanation, the rotating direction J1 of the developing roller 63 is referred to as “roller rotating direction J1” as well. The development pole N1, the peeling pole N2, and the grasping pole N3 are N poles. The first conveyance pole S1 and the second conveyance pole S2 are S poles.

The first conveyance pole S1 is an intra-housing most upstream magnetic pole section located on the most upstream side in the roller rotating direction J1 on the inside of the housing 60. The first conveyance pole S1 is located on the downstream side in the roller rotating direction J1 with respect to a position where the developing roller 63 is opposed to the photoconductive drum 12b (see FIG. 2) and on the most upstream side in the roller rotating direction J1 on the inside of the housing 60.

The sleeve 63b is formed in a cylindrical shape that includes the shaft section 63a and the plurality of magnetic pole sections N1, S1, N2, N3, and S2. The sleeve 63b is rotatable by a not-illustrated driving source. The sleeve 63b rotates counterclockwise (i.e., an arrow J1 direction). The photoconductive drum 12b (see FIG. 2) rotates clockwise along the rotating direction J1 of the sleeve 63b (i.e., the roller rotating direction J1).

The developer moves on the developing roller 63 according to the rotation of the sleeve 63b. The developer stands like ears of rice by a magnetic force when the developer passes on the magnetic pole sections N1, S1, N2, N3, and S2. Since the developer stands like ears of rice, the toner is separated from the developer and toner cloud occurs. The toner cloud is a cause of toner scattering.

The developer adheres to the developing roller 63 with a magnetic force of the grasping section N3. The developer adhering to the developing roller 63 is conveyed to the development pole N1 through the second conveyance pole S2. The development pole N1 forms a development region. In the development region, the toner included in the developer moves from the developing roller 63 toward the photoconductive drum 12b (see FIG. 2). A developed image is formed on the surface of the photoconductive drum 12b by the toner. After the developed image is formed on the surface of the photoconductive drum 12b, the developer is conveyed to the peeling pole N2 through the first conveyance pole S1. The developer adhering to the developing roller 63 is peeled by repulsion of magnetic forces of the peeling pole N2 and the grasping pole N3.

A doctor blade 66 of the opening section 60h in the housing 60 restricts a layer thickness of the developer carried by the developing roller 63.

The shield section 64 blocks a flow of air from the developing device 12a to the photoconductive drum 12b (see FIG. 2). The shield section 64 is provided between the doctor blade 66 and the photoconductive drum 12b. The shield section 64 extends from the housing 60 to close a gap between the doctor blade 66 and the developing roller 63.

The gap forming member 71 forms a first gap G1 between the gap forming member 71 and the developing roller 63. The gap forming member 71 is opposed to the developing roller 63 via the first gap G1. The gap forming member 71 is located on the opposite side of the second mixer 62 across the developing roller 63. The gap forming member 71 forms a second gap G2 between the gap forming member 71 and the housing 60. The gap forming member 71 is opposed to the housing 60 via the second gap G2. In the following explanation, a portion 73 of the housing 60 facing the gap forming member 71 via the second gap G2 is referred to as “case body 73” as well. The gap forming member 71 extends in the roller axis direction Vg (see FIG. 4).

The blocking member 72 is disposed in the first gap G1. The blocking member 72 is provided between the gap forming member 71 and the developing roller 63. The blocking member 72 is provided on the downstream side in the roller rotating direction J1 with respect to the development pole N1. The blocking member 72 is formed in a loop shape. The blocking member 72 is supported by the gap forming member 71. The blocking member 72 extends in the roller axis direction Vg. The blocking member 72 is attached to a rib 82 via the gap forming member 71. For example, a not-illustrated double-sided tape is provided in the gap forming member 71. For example, the blocking member 72 is attached to the rib 82 by the double-sided tape of the gap forming member 71.

A part of the blocking member 72 is disposed in contact with the developing roller 63, whereby, according to the rotation of the developing roller 63, the blocking member 72 functions as a wall and blocks an air current flowing into the developing device 12a. The first gap G1 is a gap between the developing roller 63 and the gap forming member 71. The blocking member 72 has a function of a valve that blocks a flow of wind including the toner flowing back in a direction opposite to the roller rotating direction J1 to flow out from the inside to the outside of the housing 60 via the first gap G1. The blocking member 72 is in contact with a developer layer (not illustrated in FIG. 3) on the developing roller 63 with a low pressure of a degree not preventing developer conveyance of the developing roller 63. The blocking member 72 does not completely prevent a flow of an air current but restricts the flow of the air current. The blocking member 72 generates an air current circulating around the gap forming member 71 and contributes to a flow of air in the developing device 12a caused by the generated air current. The blocking member 72 bends to be convex toward the developing roller 63. The blocking member 72 has flexibility. For example, the blocking member 72 is an elastic body such as urethane.

The blocking member 72 is disposed in a position opposed to the first conveyance pole S1, which is the intra-housing most upstream magnetic pole section, on the inside of the housing 60. The blocking member 72 is disposed in a position overlapping the first conveyance pole S1 in the normal direction of the developing roller 63. In other words, the blocking member 72 is disposed on the first conveyance pole S1 in the roller rotating direction J1.

An inclined surface 72a inclined toward a position where the blocking member 72 is in contact with the developer layer (not illustrated in FIG. 3) is provided in a portion opposed to the developing roller 63 on the upstream side in the roller rotating direction J1 in the blocking member 72. For example, the inclined surface 72a forms an angle equal to or larger than 1 degree and equal to or smaller than 45 degrees with respect to the tangential line of the developing roller 63.

A first opening E1 and a second opening E2 are provided between the case body 73 and the gap forming member 71.

The first opening E1 is formed on the downstream side in the roller rotating direction J1 with respect to the gap forming member 71. The first opening E1 is located on the downstream side in the roller rotating direction J1 in the second gap G2.

The second opening E2 communicates with the first opening E1 through the second gap G2. The second opening E2 is formed on the upstream side in the roller rotating direction J1 with respect to the gap forming member 71. The second opening E2 is located on the upstream side in the roller rotating direction J1 in the second gap G2.

A third opening E3 is formed on the downstream side in the roller rotating direction J1 with respect to the blocking member 72. The third opening E3 communicates with the downstream side in the roller rotating direction J1 in the first gap G1. The third opening E3 is located near the peeling pole N2.

A fourth opening E4 is formed on the upstream side in the roller rotating direction J1 with respect to the blocking member 72. The fourth opening E4 communicates with the upstream side in the roller rotating direction J1 in the first gap G1.

A part of an air current passing through the blocking member 72 flows from the third opening E3 to the first opening E1. The air current flowing to the first opening E1 flows to the second opening E2, flows through the fourth opening E4, and passes through the blocking member 72 according to the rotation of the developing roller 63 again. That is, a circulating air current is formed around the gap forming member 71. The gap forming member 71 has a function of adjusting an air current direction that determines a flow of the air current.

The case body 73 is provided on the opposite side of the developing roller 63 across the gap forming member 71. The second gap G2 is formed between the case body 73 and the gap forming member 71. The second gap G2 extends along the roller rotating direction J1. The second gap G2 communicates with the first gap G1 via the first opening E1and the third opening E3 and via the second opening E2 and the fourth opening E4.

An engaging section 93 extends to enter a recessed section 60i of the housing 60 from the case body 73. The case body 73 is detachably attached to the housing 60 by the engaging section 93. A wall section 79 forming the recessed section 60i is provided in the housing 60. The wall section 79 forms a communication path with the first opening E1 and the third opening E3 between the wall section 79 and the gap forming member 71.

The case body 73, the gap forming member 71, and the blocking member 72 configure a cover 70. The cover 70 covers the developing roller 63 from the opposite side of the second mixer 62. The cover 70 is detachably attached to the housing 60 by the engaging section 93.

The guide section 74 guides the air current discharged from the second gap G2 via the second opening E2 to somewhere between the blocking member 72 and the developing roller 63. That is, the guide section 74 guides the air discharged from the second gap G2 via the second opening E2 to the first gap G1. The guide section 74 includes a guide surface 74a opposed to the gap forming member 71 via the fourth opening E4. The guide surface 74a is the inner surface of the guide section 74 that is in contact with the air current guided by the guide section 74. The guide section 74 extends from the end portion near the second opening E2 in the housing 60 toward the developing roller 63. The guide section 74 extends from the end portion on the opening section 60h side in the case body 73 toward the developing roller 63. For example, the guide section 74 is integrally formed by the same member as the case body 73. The distal end of the guide section 74 is separated from the developing roller 63. A gap 74h is formed between the distal end of the guide section 74 and the developing roller 63.

An arrangement of the plurality of image forming units is explained.

As illustrated in FIG. 2, the plurality of image forming units 12 to 16 are disposed side by side close to one another along the intermediate transfer body 10. The plurality of image forming units 12 to 16 include a first image forming unit and a second image forming unit disposed side by side in order along a rotating direction A (i.e., a moving direction A1 illustrated in FIG. 5) of the intermediate transfer body 10. In the image forming units 12 to 16, the adjacent two image forming units have the same structure. Therefore, the image forming unit 12 representing the image forming units 12 to 16 is referred to as first image forming unit 12. The image forming unit 13 representing the image forming units 12 to 16 is referred to as second image forming unit 13. A disposition structure of the first image forming unit 12 and the second image forming unit 13 is explained.

FIG. 5 is a side view illustrating an example of the disposition structure of the first image forming unit 12 and the second image forming unit 13 in the embodiment.

As illustrated in FIG. 5, the respective photoconductive drums 12b and 13b of the first image forming unit 12 and the second image forming unit 13 are in contact with the intermediate transfer body 10 from below. The first image forming unit 12 is located on the upstream side of the second image forming unit 13 in the moving direction A1 of the intermediate transfer body 10. The first image forming unit 12 includes the cleaning unit 12d disposed on the opposite side of the developing device 12a across the photoconductive drum 12b. The first image forming unit 12 includes the charging device 12c disposed on the opposite side of the intermediate transfer body 10 across the photoconductive drum 12b.

A developing device 13a of the second image forming unit 13 includes two wall sections 68 and 69 adjacent to each other. The two wall sections 68 and 69 configure a part of a housing of the developing device 13a of the second image forming unit 13. The two wall sections 68 and 69 are adjacent to each other to form an L-shape in side view. The cleaning unit 12d of the first image forming unit 12 is surrounded by the two wall sections 68 and 69 adjacent to each other. The two wall sections 68 and 69 are a first wall section 68 and a second wall section 69.

In the side view, the first wall section 68 extends in a direction orthogonal to the moving direction A1 of the intermediate transfer body 10. The first wall section 68 extends substantially in the vertical direction. The first wall section 68 is opposed to the cleaning unit 12d of the first image forming unit 12 in the horizontal direction.

In the side view, the second wall section 69 extends in a direction parallel to the moving direction A1 of the intermediate transfer body 10. The second wall section 69 extends substantially in the horizontal direction. The second wall section 69 is opposed to the cleaning unit 12d of the first image forming unit 12 in the vertical direction.

A cleaning device 101 includes the photoconductive drum 12b, the charging device 12c, and the cleaning unit 12d. The developing device 12a is separated from the cleaning device 101. The developing device 12a is attached to an apparatus body (not illustrated in FIG. 5) individually and independently from the cleaning device 101. The developing device 12a and the cleaning device unit 101 are detachably attachable to the apparatus body.

A sub-unit 102 is configured by the photoconductive drum 12b and the cleaning unit 12d. The sub-unit 102 is separable from the charging device 12c. The charging device 12c is detachably attached to the photoconductive drum 12b. The sub-unit 102 and the charting device 12c are detachably attached to the apparatus body.

A disposition relation between the first image forming unit 12 and the second image forming unit 13 is explained.

In FIG. 5, the distance between the cleaning unit 12d of the first image forming unit 12 and the intermediate transfer body 10 is represented as H1, the distance between the developing device 13a of the second image forming unit 13 and the intermediate transfer body 10 is represented as H2, and the distance between the cleaning unit 12d of the first image forming unit 12 and the developing device 13a of the second image forming unit 13 is represented by H3. In the following explanation, the distance H1 between the cleaning unit 12d of the first image forming unit 12 and the intermediate transfer body 10 is referred to as “first distance H1” as well, the distance H2 between the developing device 13a of the second image forming unit 13 and the intermediate transfer body 10 is referred to as “second distance H2” as well, and the distance H3 between the cleaning unit 12d of the first image forming unit 12 and the developing device 13a of the second image forming unit 13 is referred to as “third distance H3” as well.

The first distance H1 means an interval between the upper surface of the cleaning unit 12d of the first image forming unit 12 and the lower surface of the intermediate transfer body 10. The upper surface of the cleaning unit 12d of the first image forming unit 12 means the upper surface of the cleaner case 12d2 of the image forming unit 12. The upper surface of the cleaning unit 12d of the first image forming unit 12 is opposed to the lower surface of the intermediate transfer body 10. The upper surface of the cleaning unit 12d of the first image forming unit 12 is substantially parallel to the lower surface of the intermediate transfer body 10.

The second distance H2 means an interval between the upper surface of the developing device 13a of the second image forming unit 13 and the lower surface of the intermediate transfer body 10. The upper surface of the developing device 13a of the second image forming unit 13 means an upper surface of a case body of the housing in the developing device 13a of the second image forming unit 13. The upper surface of the developing device 13a of the second image forming unit 13 is opposed to the lower surface of the intermediate transfer body 10. The upper surface of the developing device 13a of the second image forming unit 13 is substantially parallel to the lower surface of the intermediate transfer body 10.

The third distance H3 means an interval between a side surface of the cleaning unit 12d of the first image forming unit 12 and a side surface of the developing device 13a of the second image forming unit 13. The side surface of the cleaning unit 12d of the first image forming unit 12 means a side surface of the cleaner case 12d2 of the first image forming unit 12. The side surface of the cleaning unit 12d of the first image forming unit 12 is opposed to the side surface of the developing device 13a of the second image forming unit 13. The side surface of the cleaning unit 12d of the first image forming unit 12 is substantially parallel to the side surface of the developing device 13a of the second image forming unit 13. The side surface of the developing device 13a of the second image forming unit 13 means the outer surface of the first wall section 68 in the developing device 13a of the second image forming unit 13.

The first distance H1 is larger than the second distance H2 (H1>H2). That is, the upper surface of the cleaning unit 12d of the first image forming unit 12 is farther from the lower surface of the intermediate transfer body 10 than the upper surface of the developing device 13a of the second image forming unit 13.

The third distance H3 is smaller than the second distance H2 (H3<H2). That is, the side surface of the cleaning unit 12d of the first image forming unit 12 is close to the side surface of the developing device 13a of the second image forming unit 13 at an interval smaller than the second distance H2.

The gap 74h of the developing device 13a of the second image forming unit 13 is explained.

The gap 74h of the developing device 13a of the second image forming unit 13 functions as an air discharge port for discharging the air on the inside of the developing device 13a. The gap 74h is located further on the downstream side in the roller rotating direction J1 than a proximity section of the developing device 13a and the photoconductive drum 13b. The proximity section of the developing device 13a and the photoconductive drum 13b means a portion where the developing roller 63 of the developing device 13a and the photoconductive drum 13b are closest to each other. The gap 74h is located in a most upstream section of the housing of the developing device 13a. The most upstream section of the housing of the developing device 13a means a portion on the most upstream side in the roller rotating direction J1 in a housing upper section of the developing device 13a.

A flow of air around the developing device is explained.

FIG. 6 is a side view of the first and the second image forming unit for explaining a flow of air around the developing device in the embodiment. In FIG. 6, a flow of air around the developing device 13a located further on the downstream side in the moving direction A1 of the intermediate transfer body 10 than the developing device 12a is explained.

As illustrated in FIG. 6, the air around the developing device 13a flows in an arrow B1 direction in a space between the developing device 13a and the intermediate transfer body 10.

Near the intermediate transfer body 10, the air around the developing device 13a flows substantially in the same direction as the moving direction A1 of the intermediate transfer body 10. On the other hand, near the developing device 13a, the air around the developing device 13a flows in the opposite direction of the moving direction A1 of the intermediate transfer body 10. That is, the air around the developing device 13a circulates in the arrow B1 direction in the space between the developing device 13a and the intermediate transfer body 10. For that reason, even if the air including the toner leaks to the outside of the developing device 13a, the air including the toner circulates in the space between the developing device 13a and the intermediate transfer body 10. The air including the toner scattering from the developing device 13a circulates in the space between the developing device 13a and the intermediate transfer body 10 so as to swirl. The toner scattering from the developing device 13a adheres to at least a part of the intermediate transfer body 10, the developing device 13a (the housing), and the cleaner case 12d2. The toner adhering to the intermediate transfer body 10 is removed by the cleaning blade 11 (see FIG. 2). Even if the toner adheres to the developing device 13a or the cleaner case 12d2, it is less likely that components such as the charging device 12c are soiled.

A flow of air around a developing device in a comparative example is explained.

FIG. 7 is a side view of image forming units for explaining the flow of air around the developing device in the comparative example. In FIG. 7, a flow of air around a developing device 13aX located further on the downstream side in the moving direction A1 of an intermediate transfer body 10X than a developing device 12aX is explained.

As illustrated in FIG. 7, the air around the developing device 13aX flows in an arrow X1 direction in a space between the developing device 13aX and the intermediate transfer body 10X.

In the comparative example, the upper surface of a cleaning unit 12dX of a first image forming unit 12X is closer to the lower surface of the intermediate transfer body 10X than the upper surface of the developing device 13aX of a second image forming unit 13X. That is, the comparative example is equivalent to a case in which the first distance H1 is smaller than the second distance H2. In this case, a part of the air flowing in the space between the developing device 13aX and the intermediate transfer body 10X flows toward a charging device 12cX along a side surface of the cleaning unit 12dX (see an arrow X2). For that reason, the toner scattering from the developing device 13aX is highly likely to adhere to the charging device 12cX.

On the other hand, in the embodiment, as illustrated in FIG. 5, the upper surface of the cleaning unit 12d of the first image forming unit 12 is farther from the lower surface of the intermediate transfer body 10 than the upper surface of the developing device 13a of the second image forming unit 13. That is, the first distance H1 is larger than the second distance H2 (H1>H2). In this case, the air flowing in the space between the developing device 13a and the intermediate transfer body 10 circulates in the space between the developing device 13a and the intermediate transfer body 10 so as to swirl (see FIG. 6). For that reason, the toner scattering from the developing device 13a is less likely to adhere to the charging device 12c.

A flow of air in the developing device 12a is explained.

FIG. 8 is a sectional view of the developing device 12a in the embodiment.

As illustrated in FIG. 8, the developing roller 63 rotates in the arrow J1 direction, whereby the air flows into the housing 60 through the gap 74h. If the air flows into the housing 60, a flow of wind in arrows Q1 and Q2 directions is generated in the first gap G1. If the air enters the housing 60, since the pressure in the housing 60 increases, a flow of air in an arrow Q3 direction from the inside to the outside of the housing 60 is generated in the third opening E3.

The air flowing in the arrow Q3 direction flows toward the gap 74h while engulfing the toner separated from the developer in the housing 60. Therefore, a flow of air in arrows Q4 and Q5 directions toward the fourth opening E4 is generated in the second gap G2. If the air including the toner flows in the arrow Q5 direction, since the air including the toner is guided toward the first gap G1 by the guide surface 74a, most of the air including the toner flows into the first gap G1.

The air including the toner flowing into the first gap G1 flows in the order of the arrow Q1 direction, the arrow Q2 direction, the arrow Q3 direction, the arrow Q4 direction, and the arrow Q5 direction in the housing 60. That is, a circulation path of the flow of the air including the toner is formed in the housing 60 by the first gap G1, the second gap G2, the first opening E1, the second opening E2, the third opening E3, and the fourth opening E4.

An example of toner scattering in the developing device is explained.

FIG. 9 is a sectional view of the developing device for explaining the toner scattering therein. In FIG. 9, cross sectional hatching is omitted. The developing device illustrated in FIG. 9 does not include the gap forming member. In FIG. 9, reference numeral 160 denotes a housing, 161 denotes a first mixer, 162 denotes a second mixer, 163 denotes a developing roller, 164 denotes a shield section, 165 denotes a partition wall, 166 denotes a doctor blade, 170 denotes a cover member, 174 denotes a guide section, and 174h denotes a gap.

A developer (not illustrated in FIG. 9) is carried on the developing roller 163. As illustrated in FIG. 9, a flow of the developer drawn into the developing device is generated according to rotation of the developing roller 163. The air enters the developing device from the gap 174h (an arrow Wa in FIG. 9). If the air enters the developing device, the pressure in the developing device increases. If the pressure in the developing device increases, the air in the developing device including the toner leaks to the outside of the developing device, leading to toner scattering, indicated by an arrow Wb in FIG. 9.

A flow of air in a developing device of a circulation-type is explained.

FIG. 10 is a sectional view for explaining the flow of air in the circulation-type developing device. In FIG. 10, cross section hatching is omitted. In FIG. 10, reference numeral 271 denotes a gap forming member. For example, the gap forming member 271 is supported by a not-illustrated rib provided in the case body 73. The blocking member 72 is attached to the gap forming member 271.

The first gap G1 is provided between the gap forming member 271 and the developing roller 63. The gap forming member 271 forms the second gap G2 between the gap forming member 271 and the case body 73 (the housing). An inlet opening Ea is provided in a position on the downstream side in the roller rotating direction J1 with respect to the gap forming member 271. An outlet opening Eb is provided in a position on the upstream side in the roller rotating direction J1 with respect to the gap forming member 271. The first gap G1 and the second gap G2 communicate via the inlet opening Ea and the outlet opening Eb. For example, the first gap G1 and the second gap G2 may be formed in parallel by superimposing the gap forming member 271 on the case body 73 in a portion close to the developing roller 63.

As illustrated in FIG. 10, if the air enters the developing device from the gap 74h according to the rotation of the developing roller 63, the pressure in the developing device increases. If the pressure in the developing device increases, the air in the developing device passes through the second gap G2 from the inlet opening Ea and is discharged from the outlet opening Eb (an arrow Va in FIG. 10). The air discharged from the outlet opening Eb is drawn into the developing device by the action of the first conveyance pole S1 (arrows Vb, Vc, and Vd in FIG. 10). The first conveyance pole S1 is an intra-housing most upstream magnetic pole section located on the most upstream side in the roller rotating direction J1 in the housing. The first conveyance pole S1 has a role of drawing the air discharged from the inside to the outside of the developing device into the developing device. A layer of the developer standing like ears of rice with the magnetic force of the first conveyance pole S1 captures the air and draws the air into the developing device.

In the developing device using the technique explained above, toner scattering occurs near the gap located further on the downstream side in the roller rotating direction than the proximity section of the developing device and the photoconductive drum and in the most upstream section of the housing of the developing device. As illustrated in FIG. 6, the air including the toner scattering from the gap 74h circulates in the space between the developing device 13a and the intermediate transfer body 10 so as to swirl. Therefore, the configuration of this embodiment is particularly useful.

According to the embodiment, the image forming apparatus 1 includes the plurality of image forming units 12 to 16 and the intermediate transfer body 10. The image forming units 12 to 16 include developing devices 12a to 16a and the photoconductive drums 12b to 16b. The intermediate transfer body 10 is in contact with the respective photoconductive drums 12b to 16b of the plurality of image forming units 12 to 16. The intermediate transfer body 10 moves according to the rotation of the photoconductive drums 12b to 16b. The plurality of image forming units 12 to 16 include the first image forming unit 12 and the second image forming unit 13 disposed side by side in order along the moving direction A1 of the intermediate transfer body 10. The first image forming unit 12 includes the cleaning unit 12d disposed on the opposite side of the developing device 12a across the photoconductive drum 12b. The distance H1 between the cleaning unit 12d of the first image forming unit 12 and the intermediate transfer body 10 is larger than the distance H2 between the developing device 13a of the second image forming unit 13 and the intermediate transfer body 10. The distance H3 between the cleaning unit 12d of the first image forming unit 12 and the developing device 13a of the second image forming unit 13 is smaller than the distance H2 between the developing device 13a of the second image forming unit 13 and the intermediate transfer body 10. The configuration explained above achieves the following effect.

If the first distance H1 is smaller than the second distance H2, a part of the air flowing in the space between the developing device 13aX and the intermediate transfer body 10X easily flows toward components such as the charging device 12cX along the side surface of the cleaning unit 12dX (see FIG. 7). If the third distance H3 is larger than the second distance H2, the air flowing in the space between the developing device 13a and the intermediate transfer body 10 easily flows toward the side surface of the cleaning unit 12d. The air flowing to the side surface of the cleaning unit 12d easily flows toward the components such as the charging device 12c along the side surface of the cleaning unit 12d. For that reason, the toner scattering from the developing device 13a is highly likely to adhere to the components such as the charging device 12c. According to the embodiment, since the first distance H1 is larger than the second distance H2, the air flowing in the space between the developing device 13a and the intermediate transfer body 10 circulates in the space between the developing device 13a and the intermediate transfer body 10 so as to swirl. In addition, since the third distance H3 is smaller than the second distance H2, the air flowing in the space between the developing device 13a and the intermediate transfer body 10 less easily flows toward the side surface of the cleaning unit 12d. For that reason, it is possible to reduce the likelihood that the toner scattering from the developing device 13a adheres to the components such as the charging device 12c. Therefore, it is possible to prevent occurrence of deficiencies such as an image defect.

The developing device 13a includes the gap 74h for discharging the air on the inside of the developing device 13a. The gap 74h is located further downstream in the roller rotating direction J1 than the proximity section of the developing device 13a and the photoconductive drum 13b and in the most upstream section of the housing of the developing device 13a. The configuration explained above achieves the following effect. Toner scattering occurs near the gap 74h located further downstream in the roller rotating direction J1 than the proximity section of the developing device 13a and the photoconductive drum 13b and in the most upstream section of the housing of the developing device 13a. The air including the toner scattering from the gap 74h circulates in the space between the developing device 13a and the intermediate transfer body 10 so as to swirl. Therefore, the configuration explained above is particularly useful in reducing the likelihood that the scattering toner adheres to the components such as the charging device 12c and preventing occurrence of deficiencies such as an image defect.

The cleaning unit 12d of the first image forming unit 12 is surrounded by the two wall sections 68 and 69 adjacent to each other in the developing device 13a of the second image forming unit 13. The configuration explained above achieves the following effect. The air flowing in the space between the developing device 13a and the intermediate transfer body 10 less easily flows along the outer surface of the cleaning unit 12d. For that reason, it is possible to reduce, as much as possible, the likelihood that the toner scattering from the developing device 13a adheres to the components such as the charging device 12c. Therefore, it is possible to prevent occurrence of deficiencies such as an image defect as much as possible.

The image forming apparatus 1 includes the five image forming units 12 to 16 disposed side by side in order along the moving direction A1 of the intermediate transfer body 10. The configuration explained above achieves the following effect. Since the first distance H1 is larger than the second distance H2 and the third distance H3 is smaller than the second distance H2 in the image forming units 12 to 16, it is possible to reduce the likelihood that scattering toner adheres to the components. Therefore, in the image forming apparatus of the quintuple tandem type, it is possible to prevent occurrence of deficiencies such as an image defect.

The cleaning device 101 includes the photoconductive drum 12b, the charging device 12c, and the cleaning unit 12d. The developing device 12a is separated from the cleaning device 101. The configuration explained above achieves the following effect. It is possible to selectively detach the developing device 12a or the cleaning device 101 from the apparatus body.

The sub-unit 102 is configured by the photoconductive drum 12b and the cleaning unit 12d. The sub-unit 102 is separable from the charging device 12c. The configuration explained above achieves the following effect. It is possible to selectively detach the sub-unit 102 or the charging device 12c from the apparatus body.

The developing device 12a further includes the gap forming member 71. The gap forming member 71 forms the first gap G1 between the gap forming member 71 and the developing roller 63. The gap forming member 71 forms the second gap G2 between the gap forming member 71 and the housing 60. The gap forming member 71 is provided in the housing 60. The gap forming member 71 is provided on the downstream side in the roller rotating direction J1 with respect to the development pole N1. The first opening E1 and the second opening E2 are provided between the housing 60 and the gap forming member 71. The first opening E1 is formed on the downstream side in the roller rotating direction J1 with respect to the gap forming member 71. The second opening E2 communicates with the first opening E1 through the second gap G2. The second opening E2 is formed on the upstream side in the roller rotating direction J1 with respect to the gap forming member 71. The configuration explained above achieves the following effect. Since a circulation path of a flow of air including the toner is formed in the housing 60 by the first gap G1, the second gap G2, the first opening E1, and the second opening E2, it is possible to prevent the air including the toner from blowing out to the outside of the developing device. Therefore, it is possible to prevent scattering of the toner to the outside of the developing device.

The developing device 12a further includes the blocking member 72. The blocking member 72 is disposed in the first gap G1. The blocking member 72 is provided on the downstream side in the roller rotating direction J1 with respect to the development pole N1. The blocking member 72 is disposed in the position opposed to the first conveyance pole S1, which is the intra-housing most upstream magnetic pole section, on the inside of the housing 60. The configuration explained above achieves the following effect. Toner cloud that occurs in the first conveyance pole S1 can be confined in the developing device 12a. Therefore, it is possible to prevent scattering of the toner to the outside of the developing device 12a.

Incidentally, there is a configuration in which a filter, a fan, and the like for collecting a scattering toner in order to reduce scattering of toner to the outside of a developing device are provided. However, the number of times of clogging of the filter that captures the toner is likely to increase before a product life is exhausted. If the filter is provided, it is necessary to provide a fan and a duct as well. The apparatus is likely to increase in size. According to the embodiment, since it is unnecessary to provide the filter, maintainability is improved. The embodiment is suitable in avoiding an increase in the size of the apparatus.

The developing device 12a includes the guide section 74 that directs the air current discharged from the second gap G2 via the second opening E2 to somewhere between the blocking member 72 and the developing roller 63. The configuration explained above achieves the following effect. Since the air including the toner is guided to the first gap G1 by the guide section 74, it is possible to prevent the air including the toner from blowing out to the outside of the developing device 12a. Therefore, it is possible to prevent scattering of the toner to the outside of the developing device 12a.

The blocking member 72 is disposed in the position opposed to the first conveyance pole S1, which is the intra-housing most upstream magnetic pole section, on the inside of the housing 60. The configuration explained above achieves the following effect. Toner cloud that occurs in the first conveyance pole S1 can be confined in the developing device 12a. The blocking member 72 is suitable in preventing scattering of the toner to the outside of the developing device 12a.

A first modification of the embodiment is explained.

FIG. 11 is a side view of a first image forming unit 312 and a second image forming unit 313 in a first modification of the aforementioned embodiment.

As illustrated in FIG. 11, the image forming apparatus may further include a restricting member 300 located between the cleaning unit 12d of the first image forming unit 312 and the developing device 13a of the second image forming unit 313 when viewed from the intermediate transfer body 10.

The restricting member 300 extends from the developing device 13a of the second image forming unit 313 toward the photoconductive drum 12b of the first image forming unit 312. The restricting member 300 restricts a flow of air from the space between the developing device 13a of the second image forming unit 313 and the intermediate transfer body 10 toward the charging device 12c. The restricting member 300 is a plate member extending from an upper part of the case body of the housing in the developing device 13a of the second image forming unit 313. The restricting member 300 is integrally formed by the same member as the case body of the housing in the developing device 13a of the second image forming unit 313. The restricting member 300 is substantially parallel to the lower surface of the intermediate transfer body 10. The restricting member 300 includes an overlapping section 301 where the cleaning unit 12d of the first image forming unit 312 and the developing device 13a of the second image forming unit 313 overlap when viewed from the intermediate transfer body 10.

A disposition relation between the first image forming unit 312 and the second image forming unit 313 is explained.

In FIG. 11, the distance between the overlapping section 301 and the intermediate transfer body 10 is indicated by H4. In the following explanation, the distance H4 between the overlapping section 301 and the intermediate transfer body 10 is referred to as “fourth distance H4” as well. The fourth distance H4 means an interval between the upper surface of the overlapping section 301 and the lower surface of the intermediate transfer body 10. The upper surface of the overlapping section 301 linearly extends to the upper surface of the case body of the housing in the developing device 13a of the second image forming unit 313. The upper surface of the overlapping section 301 is opposed to the lower surface of the intermediate transfer body 10. The fourth distance H4 is substantially the same as the second distance H2 (see FIG. 5).

The first distance H1 is larger than the fourth distance H4 (i.e., H1>H4). That is, the upper surface of the cleaning unit 12d of the first image forming unit 312 is farther from the lower surface of the intermediate transfer body 10 than the upper surface of the overlapping section 301 of the second image forming unit 313.

A flow of air around the developing device is explained.

FIG. 12 is a side view of the developing device for explaining a flow of air around therein in the first modification of the aforementioned embodiment. In FIG. 12, a flow of air around the developing device 13a located further on the downstream side in the moving direction A1 of the intermediate transfer body 10 than the developing device 12a is explained.

As illustrated in FIG. 12, the air around the developing device 13a flows in an arrow C1 direction in a space between the developing device 13a and the restricting member 300 and the intermediate transfer body 10.

Near the intermediate transfer body 10, the air around the developing device 13a flows substantially in the same direction as the moving direction A1 of the intermediate transfer body 10. On the other hand, near the developing device 13a, the air around the developing device 13a flows in the opposite direction of the moving direction A1 of the intermediate transfer body 10. That is, the air around the developing device 13a circulates in the arrow Cl direction in the space between the developing device 13a and the restricting member 300 and the intermediate transfer body 10. Therefore, even if the air including the toner leaks to the outside of the developing device 13a, the air including the toner circulates in the space between the developing device 13a and the restricting member 300 and the intermediate transfer body 10. The air including the toner scattering from the developing device 13a circulates in the space between the developing device 13a and the restricting member 300 and the intermediate transfer body 10 so as to swirl. The toner scattering from the developing device 13a adheres to at least a part of the intermediate transfer body 10, the developing device 13a (the housing), the restricting member 300, and the cleaner case 12d2. The toner adhering to the intermediate transfer body 10 is removed by the cleaning blade 11 (see FIG. 2). Even if the toner adheres to the developing device 13a, the restricting member 300, or the cleaner case 12d2, the components such as the charging device 12c are less likely to be soiled.

According to the first modification, the image forming apparatus further includes the restricting member 300 located between the cleaning unit 12d of the first image forming unit 312 and the developing device 13a of the second image forming unit 313 when viewed from the intermediate transfer body 10. The configuration explained above achieves the following effect. The air flowing in the space between the developing device 13a and the restricting member 300 and the intermediate transfer body 10 circulates in the space between the developing device 13a and the restricting member 300 and the intermediate transfer body 10 so as to swirl. For that reason, it is possible to reduce, as much as possible, the likelihood that the toner scattering from the developing device 13a adheres to the components such as the charging device 12c. Therefore, it is possible to prevent occurrence of deficiencies such as an image defect as much as possible.

The restricting member 300 includes the overlapping section 301 where the cleaning unit 12d of the first image forming unit 312 and the developing device 13a of the second image forming unit 313 overlap when viewed from the intermediate transfer body 10. The configuration explained above achieves the following effect. A flow of air from the space between the developing device 13a and the intermediate transfer body 10 toward the charging device 12c can be sufficiently blocked by the overlapping section 301. Therefore, it is possible to further reduce the likelihood that the toner scattering from the developing device 13a adheres to the components such as the charging device 12c. Therefore, it is possible to further prevent occurrence of deficiencies such as an image defect.

The restricting member 300 extends from the developing device 13a of the second image forming unit 313 toward the photoconductive drum 12b of the first image forming unit 312. The configuration explained above achieves the following effect. It is easy to form a circulation path of the air in the space between the developing device 13a and the restricting member 300 and the intermediate transfer body 10. Therefore, the restricting member 300 is suitable in reducing the likelihood that the scattering toner adheres to the components such as the charging device 12c and preventing occurrence of deficiencies such as an image defect.

The restricting member 300 is substantially parallel to the lower surface of the intermediate transfer body 10. The configuration explained above achieves the following effect. Compared with a case where the restricting member 300 is nonparallel to the intermediate transfer body 10 (i.e., an extended line of the restricting member 300 crosses the intermediate transfer body 10), it is easy to form a circulation path of the air in the space between the developing device 13a and the restricting member 300 and the intermediate transfer body 10. Therefore, the restricting member 300 is suitable in reducing the likelihood that the scattering toner adheres to the components such as the charging device 12c and preventing occurrence of deficiencies such as an image defect.

A second modification of the aforementioned embodiment is explained.

FIG. 13 is a side view of a first image forming unit 412 and a second image forming unit 413 in a second modification of the embodiment. FIG. 14 is a diagram including a XIV-XIV section of FIG. 13.

As illustrated in FIG. 13, an extending end of a restricting member 400 extending from the developing device 13a of the second image forming unit 413 may be in contact with the cleaning unit 12d of the first image forming unit 412.

The extending end of the restricting member 400 is detachably connected to the cleaning unit 12d of the first image forming unit 412. An engaging member 402 that detachably engages the extending end of the restricting member 400 and the cleaning unit 12d is provided between the restricting member 400 and the cleaning unit 12d. The engaging member 402 engages with an overlapping section 401 of the restricting member 400.

As illustrated in FIG. 14, the engaging member 402 includes a hook member 403 and an axially supporting section 404. The hook member 403 is connected to the axially supporting section 404 turnably around the axially supporting section 404. An engaging recessed section 401a, in which the distal end portion of the hook member 403 is engaged, is provided in the overlapping section 401. The hook member 403 is movable between an engaging position U1 where the hook member 403 engages with the overlapping section 401 and a disengaging position U2 where the hook member 403 is disengaged from the overlapping section 401. The axially supporting section 404 extends substantially in parallel to an extending direction of the overlapping section 401 (in the paper-surface depth direction). The axially supporting section 404 is supported by the cleaner case 12d2 of the cleaning unit 12d.

According to the second modification, the extending end of the restricting member 400 is in contact with the cleaning unit 12d of the first image forming unit 412. The configuration explained above achieves the following effect. The air flowing in a space between the developing device 13a, the restricting member 400, and the cleaning unit 12d and the intermediate transfer body 10 circulates in the space between the developing device 13a, the restricting member 400, and the cleaning unit 12d and the intermediate transfer body 10 so as to swirl. Therefore, it is possible to reduce, as much as possible, the likelihood that the toner scattering from the developing device 13a adheres to the functional components such as the charging device 12c. Therefore, it is possible to prevent occurrence of deficiencies such as an image defect as much as possible.

The image forming apparatus 1 further includes the engaging member 402 that detachably engages the extending end of the restricting member 400 and the cleaning unit 12d of the first image forming unit 412. The configuration explained above achieves the following effect. It is possible to selectively detach the first image forming unit 412 or the second image forming unit 413 from the apparatus body by disengaging the extending end of the restricting member 400 and the cleaning unit 12d of the first image forming unit 412.

A third modification of the aforementioned embodiment is explained.

FIG. 15 is a side view of a first image forming unit 512 and a second image forming unit 513 in the third modification of the embodiment.

As illustrated in FIG. 15, the first distance H1 may be larger than a fifth distance H5 in portion where the cleaning unit 12d of the first image forming unit 512 and the developing device 13a of the second image forming unit 513 are close to each other. The fifth distance H5 means an interval between the upper end of the developing device 13a of the second image forming unit 513 and the lower surface of the intermediate transfer body 10 in a portion where the cleaning unit 12d of the first image forming unit 512 and the developing device 13a of the second image forming unit 513 are closest to each other. The upper end of the developing device 13a of the second image forming unit 513 means one end of a taper section 501 of the case body of the housing in the developing device 13a of the second image forming unit 513.

In the side view, the taper section 501 includes a taper surface 501a inclined with respect to the horizontal plane. In the side view, the taper surface 501a linearly extends obliquely such that a first end (e.g., an end close to the cleaning unit 12d) of the taper surface 501a is located below and a second end (e.g., an end on the opposite side of the first end) of the taper surface 501a is located above.

A fourth modification of the aforementioned embodiment is explained.

FIG. 16 is a side view of a first image forming unit 612 and a second image forming unit 613 in the fourth modification of the embodiment.

As illustrated in FIG. 16, the first distance H1 may be larger than a sixth distance H6 in a portion where the cleaning unit 12d of the first image forming unit 612 and the developing device 13a of the second image forming unit 613 are close to each other. The sixth distance H6 means an interval between the upper end of the developing device 13a of the second image forming unit 613 and the lower surface of the intermediate transfer body 10 in a portion where the cleaning unit 12d of the first image forming unit 612 and the developing device 13a of the second image forming unit 613 are closest to each other. The upper end of the developing device 13a of the second image forming unit 613 means the distal end of a projecting section 601 of the case body of the housing in the developing device 13a of the second image forming unit 613.

In the side view, the projecting section 601 includes an inclined surface 601a inclined with respect to the horizontal plane. In the side view, the inclined surface 601a linearly extends obliquely such that a first end (e.g., an end close to the cleaning unit 12d) of the inclined surface 601a is located above and a second end (e.g., an end on the opposite side of the first end) of the inclined surface 601a is located below.

Other modifications of the aforementioned embodiment are explained.

The distance H3 between the cleaning unit 12d of the first image forming unit 12 and the developing device 13a of the second image forming unit 13 is not limited to be smaller than the distance H2 between the developing device 13a of the second image forming unit 13 and the intermediate transfer body 10. For example, the third distance H3 may be equal to or larger than the second distance H2.

The restricting member 300 is not limited to include the overlapping section 301 where the cleaning unit 12d of the first image forming unit 312 and the developing device 13a of the second image forming unit 313 overlap when viewed from the intermediate transfer body 10. For example, the restricting member 300 may not include the overlapping section 301. For example, the restricting member 300 maybe disposed only between the cleaning unit 12d of the first image forming unit 312 and the developing device 13a of the second image forming unit 313.

The cleaning unit 12d of the first image forming unit 12 is not limited to be surrounded by the two wall sections 68 and 69 adjacent to each other in the developing device 13a of the second image forming unit 13. For example, the cleaning unit 12d of the first image forming unit 12 may not be surrounded by the two wall sections 68 and 69. For example, the developing device 13a of the second image forming unit 13 may not include the two wall sections 68 and 69 adjacent to each other.

The developing device 12a is not limited to be separated from the cleaning device 101. For example, the developing device 12a may be integral with the cleaning device 101.

The sub-unit 102 is not limited to be separable from the charging device 12c. For example, the sub-unit 102 may be inseparable from the charging device 12c.

The restricting member 300 is not limited to extend from the developing device 13a of the second image forming unit 313 toward the photoconductive drum 12b of the first image forming unit 312. For example, the restricting member 300 may extend from the cleaning unit 12d of the first image forming unit 312 toward the developing device 13a of the second image forming unit 313.

The restricting member 300 is not limited to be parallel to the intermediate transfer body 10. For example, the restricting member 300 may be nonparallel to the intermediate transfer body 10.

The non-developing device is not limited to be the cleaning unit 12d. For example, the non-developing device may be the photoconductive drum 12b. For example, the non-developing device may be a structure disposed on the opposite side of the developing device 12a across the photoconductive drum 12b.

The belt is not limited to be the intermediate transfer body 10. For example, the image forming apparatus 1 may not include the secondary transfer unit 30 that transfers the developed image formed on the intermediate transfer body 10 onto the sheet. For example, the belt maybe a belt that holds the sheet. For example, the developed image may be directly transferred to the sheet held by the belt.

According to the at least one embodiment explained above, the image forming apparatus 1 includes the plurality of image forming units 12 to 16 and the intermediate transfer body 10. The image forming units 12 to 16 include the developing devices 12a to 16a and the photoconductive drums 12b to 16b. The intermediate transfer body 10 is in contact with the respective photoconductive drums 12b to 16b of the plurality of image forming units 12 to 16. The intermediate transfer body 10 moves according to the rotation of the photoconductive drums 12b to 16b. The plurality of image forming units 12 to 16 include the first image forming unit 12 and the second image forming unit 13 disposed side by side in order along the moving direction A1 of the intermediate transfer body 10. The first image forming unit 12 includes the cleaning unit 12d disposed on the opposite side of the developing device 12a across the photoconductive drum 12b. The distance H1 between the cleaning unit 12d of the first image forming unit 12 and the intermediate transfer body 10 is larger than the distance H2 between the developing device 13a of the second image forming unit 13 and the intermediate transfer body 10. The distance H3 between the cleaning unit 12d of the first image forming unit 12 and the developing device 13a of the second image forming unit 13 is smaller than the distance H2 between the developing device 13a of the second image forming unit 13 and the intermediate transfer body 10. The configuration explained above achieves the following effect.

If the first distance H1 is smaller than the second distance H2, apart of the air flowing in the space between the developing device 13a and the intermediate transfer body 10 easily flows toward the functional components such as the charging device 12c along the side surface of the cleaning unit 12d (see FIG. 7). If the third distance H3 is larger than the second distance H2, the air flowing in the space between the developing device 13a and the intermediate transfer body 10 easily flows toward the side surface of the cleaning unit 12d. The air flowing to the side surface of the cleaning unit 12d easily flows toward the functional components such as the charging device 12c along the side surface of the cleaning unit 12d. Therefore, the toner scattering from the developing device 13a is highly likely to adhere to the functional components such as the charging device 12c. According to the embodiment, since the first distance H1 is larger than the second distance H2, the air flowing in the space between the developing device 13a and the intermediate transfer body 10 circulates in the space between the developing device 13a and the intermediate transfer body 10 so as to swirl. In addition, since the third distance H3 is smaller than the second distance H2, the air flowing in the space between the developing device 13a and the intermediate transfer body 10 less easily flows toward the side surface of the cleaning unit 12d. Therefore, it is possible to reduce the likelihood that the toner scattering from the developing device 13a adheres to the components such as the charging device 12c. Therefore, it is possible to prevent occurrence of deficiencies such as an image defect.

While certain embodiments have been described, these embodiments have been presented by way of example only and are not intended to limit the scope of the inventions. Indeed, the novel embodiments described herein may be embodied in a variety of other forms: furthermore various omissions, substitutions and changes in the form of the embodiments described herein maybe made without departing from the spirit of the inventions. The accompanying claims and their equivalents are intended to cover such forms or modifications as would fall within the scope and spirit of the invention.

1. An image forming apparatus comprising:
adjacent first and second image forming units, each including a developing device, a non-developing device, and an image carrier between the developing device and the non-developing device, wherein the non-developing device of the first image forming unit is adjacent to the developing device of the second image forming unit; and
a belt above the developing device, the non-developing device, and the image carrier of each of the first and second image forming units, and configured to move as the image carrier rotates, wherein
a first gap between an upper surface of the non-developing device of the first image forming unit and the belt is larger than a second gap between an upper surface of the developing device of the second image forming unit and the belt and
a third gap between a side surface of the non-developing device of the first image forming unit and a side surface of the developing device of the second image forming unit is smaller than the second gap.

2. The apparatus according to claim 1, further comprising:
a restricting member that extends from the upper surface of the developing device of the second image forming unit toward the image carrier of the first image forming unit.

3. The apparatus according to claim 2, wherein
a portion of the restricting member overlaps a portion of the upper surface of the non-developing device of the first image forming unit when viewed from the belt.

4. The apparatus according to claim 3, wherein
the restricting member is parallel to the belt.

5. The apparatus according to claim 4, wherein
an extending end of the restricting member contacts the non-developing device of the first image forming unit.

6. The apparatus according to claim 5, further comprising:
an engaging member that engages the extending end of the restricting member and the non-developing device of the first image forming unit.

7. The apparatus according to claim 1, wherein
the non-developing device of the first image forming unit is adjacent to two contiguous walls of the developing device of the second image forming unit.

8. The apparatus according to claim 1, wherein
the non-developing device is a cleaning unit.

9. The apparatus according to claim 1, wherein
the image carrier is a photoconductive drum.

10. The apparatus according to claim 1, wherein
the first image forming unit has a housing that houses the image carrier and a gap forming member to form a gap between the image carrier and a portion of the housing parallel to the belt.

11. The apparatus according to claim 10, wherein
the first image forming unit has a blocking member configured to prevent air flow caused by rotation of the image carrier in a gap between the gap forming member and the image carrier.

12. The apparatus according to claim 11, wherein
the first image forming unit has a guide section that guides air flow from the gap between the image carrier and the portion of the housing toward the blocking member so that air circulates around the gap forming member and the blocking member within the housing.

13. The apparatus according to claim 12, wherein
the blocking member extends in a rotation axis direction of the image carrier.

14. An image forming apparatus comprising:
adjacent first and second image forming units, each including a developing device, a non-developing device, and an image carrier between the developing device and the non-developing device, wherein the non-developing device of the first image forming unit is adjacent to the developing device of the second image forming unit; and
a belt above the developing device, the non-developing device, and the image carrier of each of the first and second image forming units, and configured to move as the image carrier rotates, wherein
a first gap between an upper surface of the non-developing device of the first image forming unit and the belt is larger than a second gap between an upper surface of the developing device of the second image forming unit and the belt,
a third gap between an upper surface of the developing device of the first image forming unit and the belt is equal in size to the second gap, and
a fourth gap between an upper surface of the non-developing device of the second image forming unit and the belt is equal in size to the first gap.

15. The apparatus according to claim 14, wherein
a fifth gap between a side surface of the non-developing device of the first image forming unit and a side surface of the developing device of the second image forming unit is smaller than the second gap.

16. The apparatus according to claim 14, further comprising:
a restricting member that extends from the upper surface of the developing device of the second image forming unit toward the image carrier of the first image forming unit.

17. The apparatus according to claim 16, wherein
a portion of the restricting member overlaps a portion of the upper surface of the non-developing device of the first image forming unit when viewed from the belt.

18. The apparatus according to claim 17, wherein
the restricting member is parallel to the belt.

19. The apparatus according to claim 18, wherein
an extending end of the restricting member contacts the non-developing device of the first image forming unit.

20. The apparatus according to claim 19, further comprising:
an engaging member that engages the extending end of the restricting member and the non-developing device of the first image forming unit.
